(19) United States
(12) Patent Application Publication
(10) Pub. No.: US 2023/0272929 A1
(43) Pub. Date: Aug. 31, 2023

(54) SPACE CONDITIONING CONTROL AND MONITORING METHOD AND SYSTEM

(71) Applicant: WaterFurnace International, Inc., Fort Wayne, IN (US)

(72) Inventor: Robert R. Brown, Markle, IN (US)

(21) Appl. No.: 18/089,981

(22) Filed: Dec. 28, 2022

Related U.S. Application Data
(60) Provisional application No. 63/295,746, filed on Dec. 31, 2021.

(51) Int. Cl. F24F 11/30; F24F 11/50; G05B 19/042

(52) U.S. Cl. CPC F24F 11/30; F24F 11/50; G05B 19/042; G05B 2219/2614

(57) ABSTRACT

An AID application including processing instructions operable by a processor to: present a graphical user interface (GUI) on a display screen, the GUI operable to receive user parameter values from a user; receive monitored parameter values from a space conditioning unit (SCU) controller; perform an auto-commissioning routine using the user parameter value and the monitored parameter values, the auto-commissioning routine including: generating a command for the SCU controller to place the SCU in heating and cooling modes; receiving the monitored parameter values in the heating and cooling modes and comparing the monitored parameter values to a model; based on the comparison, determining if the monitored parameter values are within expected or unexpected ranges, taking a first action if the monitored parameter values are within the expected ranges; an taking a second action if the monitored parameter values are within the unexpected ranges.

### CROSS-REFERENCE TO RELATED APPLICATIONS

This application claims the benefit under 35 U.S.C. § 119(e) of U.S. Provisional Application No. 63/295,746, filed on Dec. 31, 2021 which is incorporated by reference in its entirety.

### TECHNICAL FIELD

The disclosure relates generally to methods and systems to control air temperatures in spaces. More particularly, the disclosure relates to installation and troubleshooting methods and systems for space conditioning systems.

### BACKGROUND OF THE DISCLOSURE

A space conditioning system is configured to exchange heat between the environment and a target space to condition the space therein. Space conditioning systems have a load loop coupled to a source loop. The load loop exchanges thermal energy with the target space. The source loop transfers energy between the environment and the load loop. Exemplary space conditioning systems include source/load loop combinations such as liquid/air, liquid/liquid, air/liquid and air/air. Liquid load loops include, for example, radiant floor systems.

A typical space conditioning system may include a compressor that circulates a refrigerant in a load loop to extract or inject heat from or to a target space. An indoor coil, a motor-driven fan blowing air through the coil to condition the air, and control logic cooperate to maintain a target temperature in the target space. A heater, e.g. gas or electric, may be provided to heat the target space in winter. The control logic controls the compressor and fan motors. The fan, or blower, may be driven by a variable speed drive. Generally, a condenser rejects heat to the air outside the conditioned space, e.g. to the outside environment. The heat may also be transferred by a fluid to the earth in an earth ground loop.

A heat pump system is a space conditioning system that provides both heating and cooling by reversing the flow of refrigerant. The heat pump system extracts heat from the target space in a cooling mode and injects heat in a heating mode. In winter, the heat pump system may receive heat from the source loop and exchange the heat with the load loop to heat the target space. The heater may provide auxiliary heat in winter.

Traditionally, a thermostat connected to the control logic enables a user to set target temperatures according to a programmable schedule. Users may program temperature setpoints to save energy. For example, users may program daytime temperature setpoints, when a home is typically unoccupied, to be lower than a comfortable cold temperature in winter and higher than a comfortable hot temperature in summer.

Space conditioning systems require motors, compressors, valves, control systems and other equipment to function, as described above. The components are not easily isolated therefore installing and troubleshooting them can be challenging and time consuming. Additionally, the systems can be inoperable while parts are procured to effect repairs. Accordingly, there is a need to provide cost effective devices to improve installation and troubleshooting efficiencies.

### SUMMARY

Embodiments of a space conditioning system and a method of monitoring a space conditioning system are disclosed herein.

In one aspect, a space conditioning system can include an AID application including processing instructions operable by a processor to: present a graphical user interface (GUI) on a display screen, the GUI operable to receive user parameter values from a user; receive monitored parameter values from a space conditioning unit (SCU) controller; perform an auto-commissioning routine using the user parameter value and the monitored parameter values, the auto-commissioning routine including: generating a command for the SCU controller to place the SCU in heating and cooling modes; receiving the monitored parameter values in the heating and cooling modes and comparing the monitored parameter values to a model; based on the comparison, determining if the monitored parameter values are within expected or unexpected ranges; taking a first action if the monitored parameter values are within the expected ranges; and taking a second action if the monitored parameter values are within the unexpected ranges.

In another aspect, the space conditioning system can further include a SCU including the SCU controller. In a further aspect, the space conditioning system can further include an AID link wired to the SCU and providing an access point to transmit the monitored parameter values to the AID application and to receive from the AID application the user parameter values from the user. In a further aspect, the SCU can include an SCU identifier and wherein the processing instructions of the AID application are configured to receive the SCU identifier and to select a model based on the SCU identifier. In a further aspect, the SCU can includes an SCU identifier and wherein the processing instructions of the AID application are configured to receive the SCU identifier and to reconfigure a general model into the model based on the SCU identifier. In a further aspect, first action can include storing the monitored parameter values to verify installation based on the auto-commissioning routine. In a further aspect, the second action includes presenting topical troubleshooting content. In a further aspect, the auto-commissioning routine can include processing instructions configured to store control-verified parameter values. In a further aspect, the processing instructions of the AID application can be configured to present a calculator operable to convert an SCU parameter value into a measurable parameter value and to receive a user input comprising the measurable parameter value. In a further aspect, the auto-commissioning routine can include processing instructions configured to calculate an estimated refrigerant charge based upon an air handler/coil, a condensing unit and a line set diameter and length. In a further aspect, the auto-commissioning routine can include processing instructions configured to compare refrigerant pressures, temperatures, superheat and subcooling to determine if an amount of the refrigerant charge in the space conditioning system is sufficient. In a further aspect, the auto-commissioning routine can include processing instructions configured to present an amount of increase or decrease of the refrigerant charge if the amount of the refrigerant charge in the space conditioning system is not sufficient.

In a further aspect of the present invention, a space conditioning system including an AID application can include processing instructions operable by a processor to: present a graphical user interface (GUI) on a display screen, the GUI operable to receive user parameter values from a user; communicate with an SCU controller of a space conditioning unit; receive monitored parameter values from the SCU controller; and perform a charge assist routine based upon the user parameter values and the monitored parameter values. In some aspects, the user parameter can include a coolant line length, the monitored parameter values can include a refrigerant temperature and/or a refrigerant pressure, and the charge assist routine can include: calculating an amount of refrigerant to charge into a coolant line based upon the coolant line length, and determining if a correct amount of refrigerant has been supplied to the space conditioning system based upon a determined steady state operation of the space conditioning system. In further aspects, the determination of the steady state operation can include: generating a command for the SCU controller to place the space conditioning unit in a heating mode or a cooling mode; receiving the monitored parameter values during the heating mode or the cooling mode; comparing the monitored parameter values to a model; and determining if the monitored parameter values are within an expected range or an unexpected range for a predetermined timeframe. In a further aspect, when the monitored parameter values are determined to be within the expected range for the predetermined timeframe, the space conditioning system automatically generate an indication displayed on the GUI confirming that a correct amount of refrigerant has been supplied, or when the monitored parameter values are within the unexpected range, the space conditioning system automatically generate an indication displayed on the GUI alerting that an incorrect amount of refrigerant has been supplied.

In a further aspect of the present invention, a space conditioning system can include an AID application including processing instructions operable by a processor to: present a graphical user interface (GUI) on a display screen, the GUI operable to receive user parameter values from a user; communicate with an SCU controller of a space conditioning unit; receive monitored parameter values from the SCU controller; and perform one or more routines based upon the user parameter values and the monitored parameter values. In some respects, the one or more routines can include a troubleshooting routine, the troubleshooting routine including: performing a diagnostic routine including determining if the monitored parameter values are within an expected range or an unexpected range, and based upon the determination of the unexpected range, displaying troubleshooting content on the GUI indicating a flowchart for troubleshooting a parameter associated with the space conditioning system. In further aspects, the one or more routines can be a performance diagnostic routine, the performance diagnostic routine including performing a diagnostic routine including determining if the monitored parameter values are within an expected range or an unexpected range, and based upon the determination, optimizing the operation of the space conditioning system based upon adjusting a parameter associated with the space conditioning unit by communicating with the SCU controller, the optimizing automatically enhancing the performance of the space conditioning system. In further aspects, the one or more routines can be a functional troubleshooting routine, the functional troubleshooting routine including: automatically generating responses to one or more user questions relating to the space conditioning unit and displaying the responses on the GUI; displaying one or more flowcharts on the graphical user interface relating to the space conditioning unit in response to the user parameter values and the monitored parameter values; and/or displaying one or more videos on the GUI relating to the space conditioning unit in response to the user parameter values and the monitored parameter values.

### BRIEF DESCRIPTION OF THE DRAWINGS

The above-mentioned and other disclosed features, the manner of attaining them, and the benefits and advantages thereof, will become more apparent and will be better understood by reference to the following description of disclosed embodiments taken in conjunction with the accompanying drawings, wherein:

FIG. 1 is a conceptual diagram of a space conditioning system in accordance with an embodiment set forth in the disclosure;

FIG. 2 is a block diagram of a space conditioning system in accordance with an embodiment set forth in the disclosure;

FIG. 3 is a schematic diagram of a motor drive system in accordance with an example set forth in the disclosure;

FIG. 4 is a schematic diagram of a heat pump system with an air source system in accordance with another example set forth in the disclosure;

FIG. 5A is a block diagram of an embodiment of a controller in accordance with an embodiment set forth in the disclosure;

FIG. 5B is a perspective view of a space conditioning unit including a mobile device and AID Application;

FIG. 6 is a flowchart of an installation and troubleshooting method in accordance with an example set forth in the disclosure; and

FIG. 7 is a flowchart of an auto-commissioning process in accordance with an example set forth in the disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present invention. The exemplification set out herein illustrates embodiments of the disclosure, and such exemplifications are not to be construed as limiting the scope of the invention in any manner.

### DETAILED DESCRIPTION

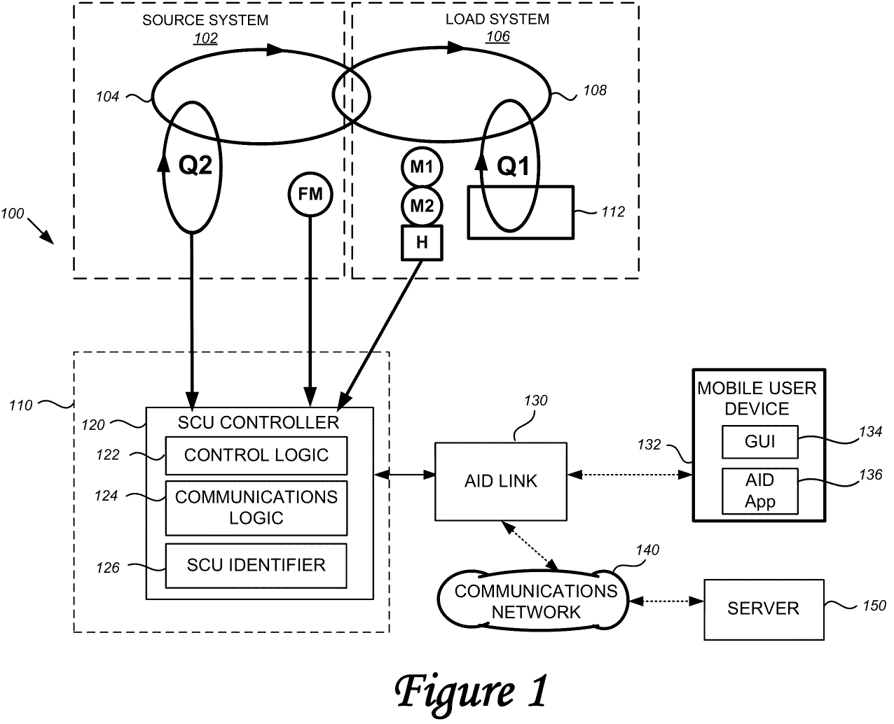

FIG. 1 is a conceptual diagram of an embodiment of a space conditioning system, denoted by numeral 100. Space conditioning system 100 includes a load loop 108 and a source loop 104. Load loop 108 is configured to add or remove heat Q1 to/from a target space 112. Source loop 104 is configured to exchange heat with load loop 108 and to add or remove heat Q2 to/from the environment. A space conditioning unit (SCU) 110 includes a SCU controller 120 that controls a target temperature of target space 112 by controlling load loop 108 and source loop 104. Source and load loops may use a fluid medium such as air or a liquid, e.g. water as the energy exchange medium. Exemplary source/load loop combinations include liquid/air, liquid/liquid, air/liquid and air/air. Liquid source loops may be ground coupled, groundwater coupled, and water loop coupled, e.g. coupled to a cooling tower/boiler. SCU 110 may include, in addition to SCU controller 120, plumbing, sensors, valves, motor controllers, and other known components of space conditioning systems, which are controlled by SCU controller 120 and provide parameter data to SCU controller 120.

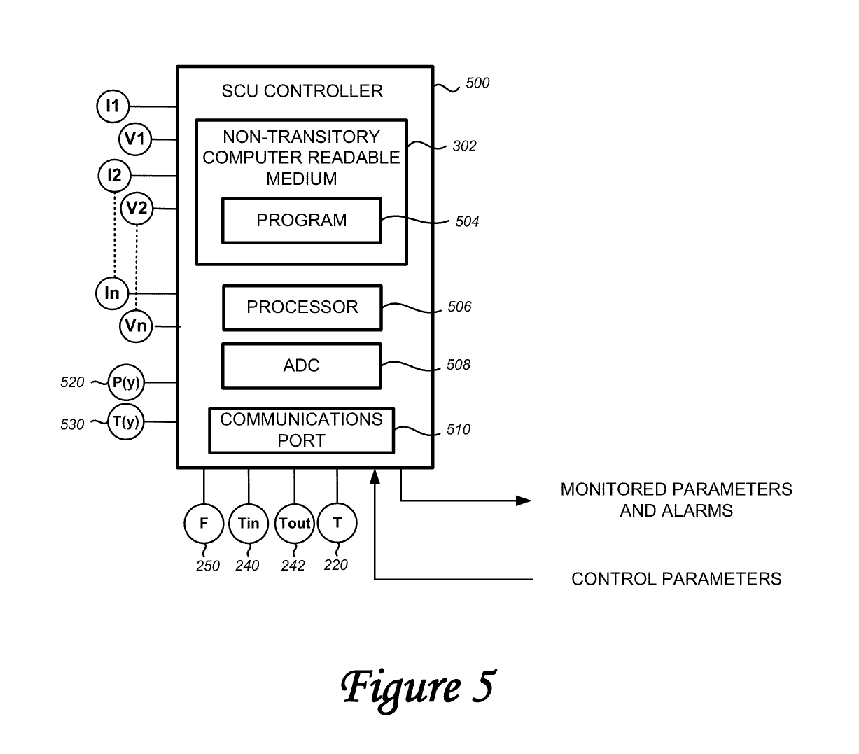

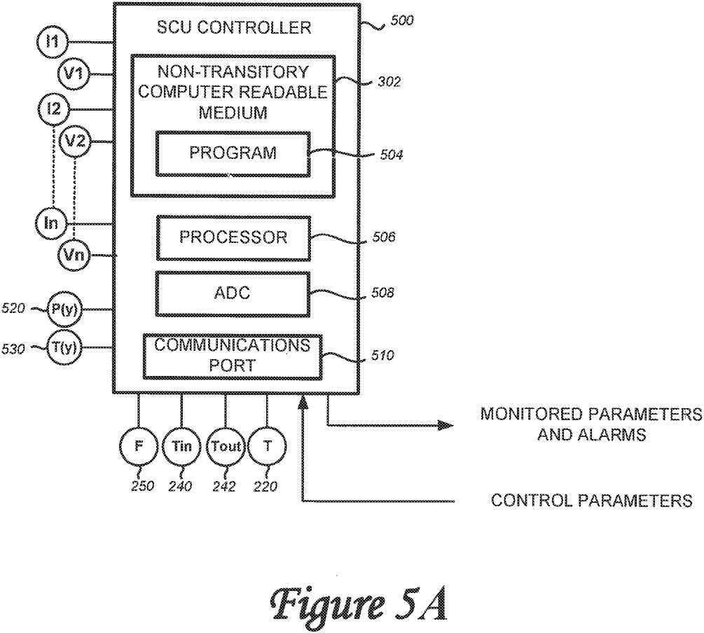

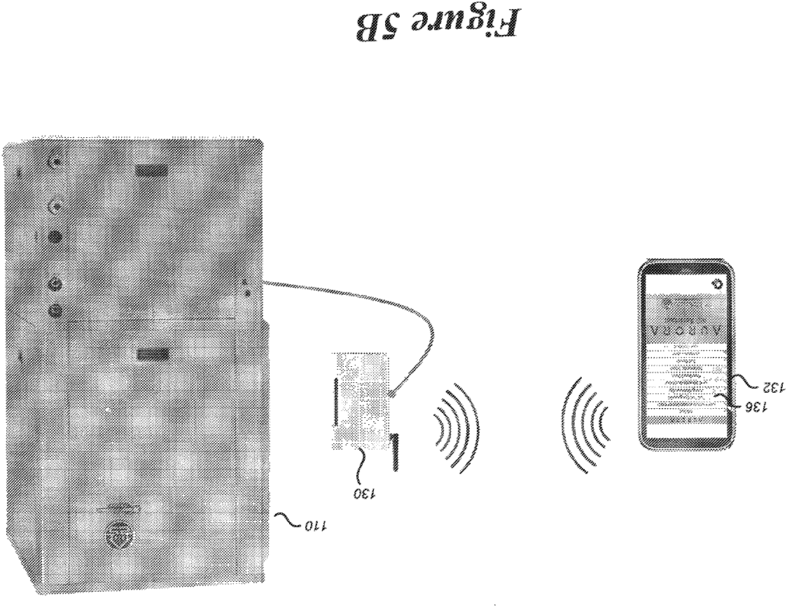

In the present embodiment, SCU controller 120 includes control logic 122 and communications logic 124. Control logic 122 comprises any known or future developed logic to operate SCU 110. Communications logic 124 includes processing instructions to communicate operating parameters of the SCU to an aid link 130 and to receive processing instructions from the aid link 130. The processing instructions are then communicated by communications logic 124 to control logic 122 for implementation. Processing instructions may include instructions to turn on a motor, for example. In some embodiments, aid link 130 is a device external and separate from SCU controller 120. This implementation is useful in retrofit applications or as an economic approach to offer a low cost SCU with the option to add specialized logic. In some embodiments, the functionality of aid link 130 is incorporated in communications logic 124. Aid link 130 can be wired to SCU controller 120 to communicate data and instructions with control logic 122. The wired connection may implement a known communications protocol such as ethernet, parallel, or serial communications. FIG. 5B is a perspective view showing aid link 130 wired to SCU 110.

In some embodiments, aid link 130 includes a WiFi access point and controller operable to serve web pages to connected devices. An example of a connected device may be a mobile user device 132 comprising a graphical user interface (GUI) 134. Example mobile user devices include phones, tablets, and portable computers.

In some embodiments, the mobile user device 132 may communicate directly with communications logic 124 over a known short-range wireless protocol. Mobile user device 132 includes GUI 134. Example short-range wireless protocols include Bluetooth and Zigbee. In the present embodiment, the troubleshooting and other logic described below is included in an aid application installed in the mobile user device. As used herein, the aid application comprises code downloadable into the mobile device, which code is executed upon activation of an icon on a display screen of the device. Embodiments of communications logic 124 may include an interface to communicate with a smart utility meter, an interface to communicate with GUI 134, and an interface to communicate with a communications network 140. These interfaces and their mode of operation are well known in the art. Mobile devices include smart phones, IPAD(™) IPHONE(™), ITOUCH(™) and GOOGLE(™) devices, and computing devices. User interfaces may also be used to communicate with communications logic 124 via communications network 140. Communications network 140 is connected via the Internet to a server 150.

Server 150 comprises a server application that receives parameter data from multiple SCU systems and can link with various applications to remotely monitor each of the multiple SCU systems. The server application can also issue commands such as fault alerts based on fault data received from the aid application or the aid link.

Regardless of the communication structure, mobile user device 132 is operable to receive user instructions and present information to the user on a display screen. In the WiFi implementation, GUI 134 presents information received from aid link 130. In the short-range application, the information is provided by the application installed in mobile user device 132. In both implementations, the SCU controller communicates data as required by the troubleshooting logic.

The SCU controller is configured to receive temperature, humidity, flow and other parameter signals, depending on the type of system, from sensors coupled to source loop 104 and load loop 108.

While the embodiments described herein are described with reference to a target space being, generally, air in a facility, the embodiments are not so limited. The embodiments described herein may find utility in any system to exchange energy. In one example, source loop 104 is coupled to a water heater. Source loop 104 is then able to inject heat to the water heater. In another example, source loop 104 is coupled with a refrigeration unit. Source loop 104 is then able to reject heat from the refrigeration unit to the environment. In a further example, source loop 104 is coupled with a combustion engine, e.g. a generator, to exchange energy with the engine. The engine may require heat before starting in winter or may require cooling to operate efficiently in summer. A heat exchanger may be provided or the apparatus may incorporate heat exchanging structure, e.g. piping and fans or pumps. A thermocouple may be affixed directly to the apparatus. Heat of extraction/rejection may be calculated based on temperature changes to the structure of the apparatus. The source loop may be coupled to heat and/or cool any other apparatus. SCU controller 120 may then control a target temperature of the apparatus.

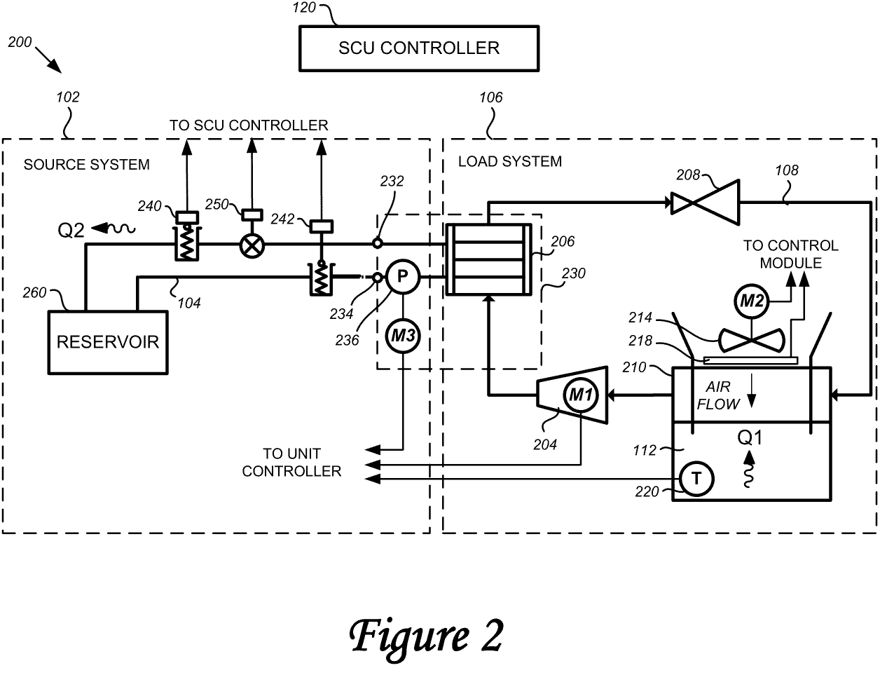

FIG. 2 is a block diagram of an embodiment of a liquid/liquid space conditioning system, denoted by numeral 200. In the present embodiment, load loop 108 includes a compressor unit 204 including a motor M1, a condenser unit 206, an expansion valve 208 and a coil unit 210. Adjacent coil unit 210 are a coil fan 214 driven by a motor M2, and a heater 218. An electric heater is shown. Coil fan 214 is driven by a variable speed drive to blow air through coil unit 210 into target space 112. In winter, air is heated by heater 218, if necessary. A temperature sensor 220 provides a temperature signal indicative of the temperature in target space 112 to SCU controller 120. Temperature sensor 220 may be comprised in a thermostat (not shown) or may be provided separately, as known in the art. A user may program the thermostat with the setpoint temperatures. The thermostat may provide on/off signals to initiate and suspend heating and cooling. Alternatively, the user may utilize a user interface or a computing device, e.g. mobile user device 132 and GUI 134, to program setpoint temperatures in SCU controller 120, which in the present example includes temperature control logic (not shown) that determines if heating or cooling are required and takes the appropriate heating or cooling control action.

A unit 230 includes condenser 206, a pump 236, an outlet port 232 and an inlet port 234. Pump 236, powered by a motor M3, circulates liquid out of outlet port 232 and draws the liquid from reservoir 260 which flows through inlet port 234 to complete the loop. The outflow and inflow temperatures of the liquid are sensed, respectively, by temperature sensors 240 and 242. The outflow and inflow temperatures may be sensed, respectively, near outlet port 232 and an inlet port 234. A flow sensor 250 generates a flow signal configured to determine the flow rate of the fluid in source loop 104. Mass flow is determined based on flow rate. Energy exchange is based on mass flow and the temperature differential. These variables may also be determined by sensing flow and temperature on the load side of condenser 206, for example. Exemplary reservoirs include tanks, wells, lakes, loops including earth ground and water loops, and any other structure configured to contain liquids.

The term “logic” or “control logic” as used herein includes software and/or firmware executing on one or more computers, central processing units, programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed.

The terms “circuit” and “circuitry” refer generally to hardwired logic that may be implemented using various discrete components such as, but not limited to, diodes, bipolar junction transistors, field effect transistors, etc., which may be implemented on an integrated circuit using any of various technologies as appropriate, such as, but not limited to CMOS, NMOS, PMOS etc.

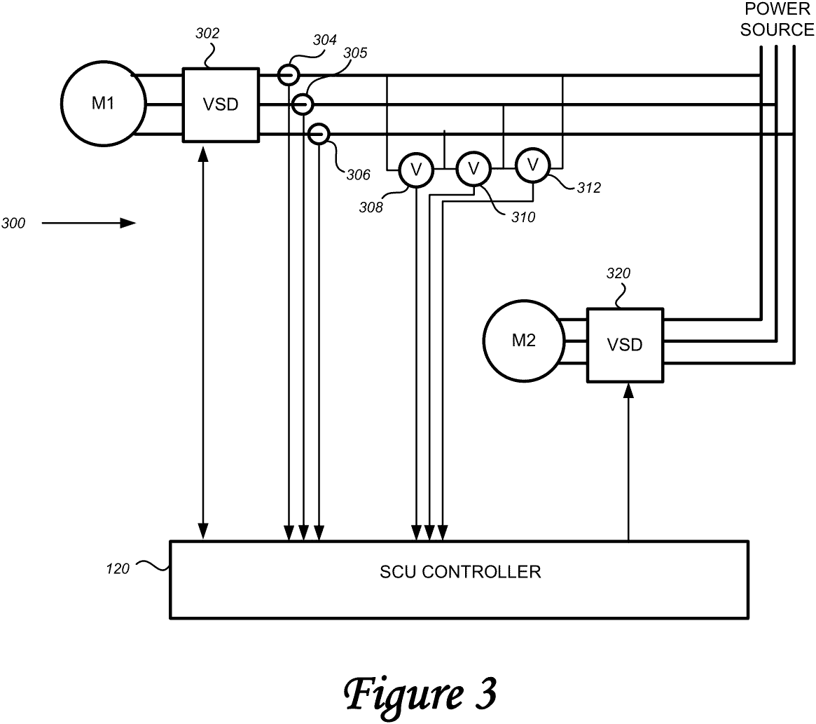

FIG. 3 is a block diagram of an exemplary motor drive system 300 including SCU controller 120. Motors M1 and M2 are shown, powered by variable speed drives (VSD) 302 and 320, respectively, which receive three-phase power from the same power source. Voltage meters 308, 310 and 312 sense the phase-to-phase voltages of the power source and provide corresponding voltage signals to SCU controller 120. As stated above, a user may provide a calibration factor, such as a power factor, to SCU controller 120 to calibrate the monitored parameter. In the present embodiment, current transformers 304, 305 and 306 provide current signals corresponding to the current drawn on three phases of the power source by VSD 302. VSD 320 has the capability to determine the current drawn by motor M2 and to communicate the sensed current signal to SCU controller 120. In one example, VSD 320 may communicate the power consumed by motor M2. SCU controller 120 then calculates power consumed by motors M1 and M2. The same topology is used to sense power consumed by motors M3 and M4, the electric heater, and any other fans and pumps of the heat pump system. SCU controller 120 may also receive voltage and current signals from additional voltage and current sensors configured to sense phase voltages and additional line currents of single or three-phase power consumers. Different voltage and current sensor arrangements may be configured to provide a meaningful power computation while managing installation and equipment costs to suit each facility.

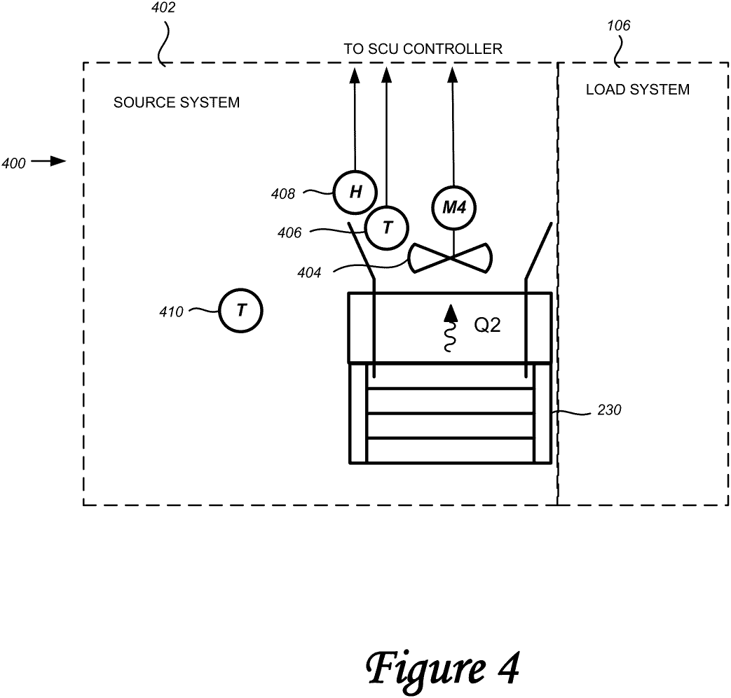

Mass flow may also be determined for air loops. An exemplary air source loop is described with reference to FIG. 4. Energy exchanged by the space conditioning system can similarly be determined for air based load loops by acquiring corresponding sensor data.

FIG. 4 is a block diagram of an embodiment of a heat pump system, denoted by numeral 400, with an air source loop. System 400 includes load system 106. System 400 also includes a source system 402 including a fan 404 ventilating condenser 230. Fan 404 is driven by motor M4. The temperature and humidity of the ventilated air is sensed by temperature sensor 406 and humidity sensor 408. The ambient temperature is sensed by temperature sensor 410. The ventilated air flow may be determined based on the speed and surface area of fan 404. The temperature differential between the ventilated air and the ambient air, together with the ventilated air humidity, may be used to calculate the heat of extraction/rejection of the system and the COP. In another embodiment, a space conditioning system comprises an air load loop. In one example, the air load loop is thermally coupled to an air source loop. In a further example, the air load loop is thermally coupled to a liquid source loop, e.g. a water loop.

As with many traditional HVAC systems, installation, commissioning, and troubleshooting of heat pump units can be difficult and may require a dedicated technician to perform these functions which, due to the complexity of the systems, can take a large amount of time. This can lead to higher costs of the installation, commissioning, and troubleshooting.

One aspect of the aid application (described above, “AID App”) is to aid field technicians in the installation, commissioning, and troubleshooting of HVAC units, and in particular, ones utilizing a heat pump system. Generally, these functions are based on a) communication with the unit’s controller, b) access to current and past operating parameter values, c) automation of functions typically performed by a technician, and d) provision of related instructions and information in various digital formats.

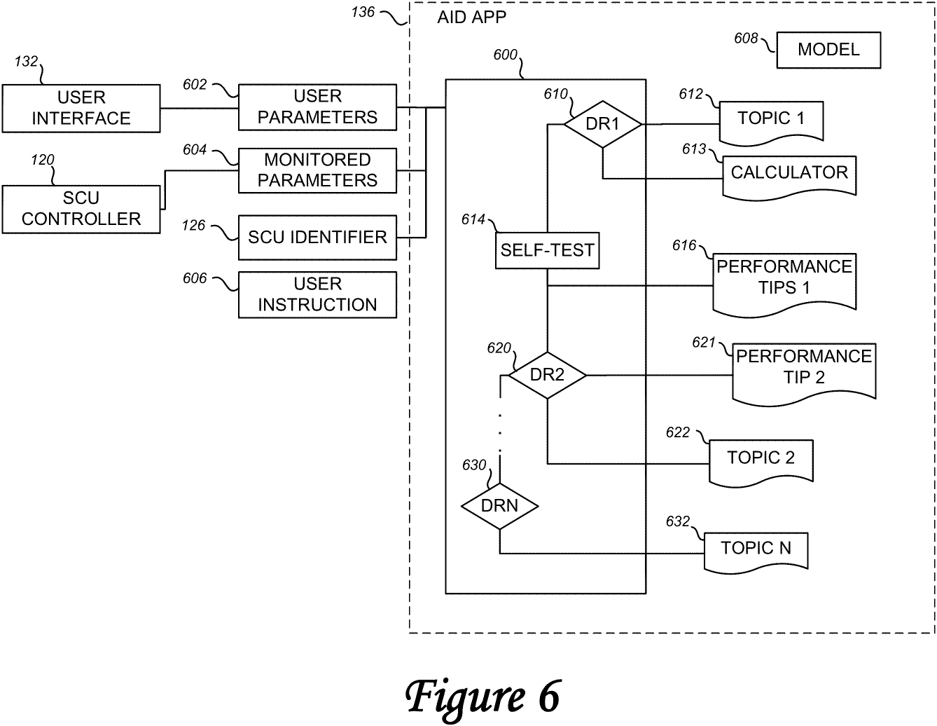

In prior art systems, troubleshooting applications relied on user input information. Because sensors are costly they are often omitted. Using a large suite of sensors enables the AID App to self-verify information by comparing sensor data with models. Because there is no user involvement, self-verification can be trusted for the purpose of validating that the system was installed correctly, to define operating baselines, and to validate warranty claims. Of course, the AID App also integrates data entered by a user. An example AID App is shown in FIG. 1 as AID App 136 and described with reference to FIG. 6.

The AID App can facilitate split unit charge assist, active unit and accessory startup and configuration assistance, system registration, active unit and accessory troubleshooting assistance, loop antifreeze calculation and measurement assistance, component parameter lookup for compressor, and major replacement part number lookup. The AID App can also provide topical troubleshooting content. Troubleshooting content may include smart calculators, videos, technical literature and technical bulletins, troubleshooting procedures, and service/install videos from a web-based video channel. Tech Video Access

Specific short videos (2-5 minutes) can be hot linked to specific diagnostic issues identified by the AID App (see e.g. Topic 1, Topic 2, etc. at FIG. 6 with reference to 612, 622). For instance, when diagnosing a potentially failed fan motor, a link is displayed by the GUI directing the user to a pertinent video outlining troubleshooting techniques for the fan motor. The GUI can also present user input fields with which the user can provide user parameter values.

FIG. 5A is a block diagram of an embodiment of an SCU controller 500. SCU controller 500 includes non-transitory computer readable medium 302 having stored therein a program 504 configured to cause a processor 506 to execute program instructions configured to perform the functions described previously with reference to SCU controller 120. SCU controller 500 further includes a communications port 510, as known in the art, operable to transmit monitored parameters and alarms and to receive control parameters as described above with reference to FIGS. 1-3. Communications logic 124 may comprise communications port 510.

SCU controller 500 further includes an analog to digital converter (ADC) circuit 508 configured to read analog signals. Analog signals may be provided by voltage and current sensors I(x) and V(x), a plurality of pressure and temperature sensors P(y) 520 and T(y) 530, respectively, operable to read coil and condenser pressures and temperatures, and other pressures and temperatures, temperature sensors 240 and 242, and flow sensor 250. Sensors I(x) and V(x) are provided to sense single or three-phase power, based on the load type. Additional circuits may be provided to convert temperature signals to voltages or currents in the event the temperature sensors do not perform such conversion. Any of the sensors described herein may include an ADC circuit to convert the corresponding sensed values to digital values and a communication port, e.g. a serial communication port, to communicate the digital value to SCU controller 500, as known in the art. SCU controller 500 may also include multiplexing logic for multiplexing the analog signals, as known in the art. Control logic 122 may comprise non-transitory computer readable medium 302, ADC circuit 508, and processor 506.

FIG. 5B is a perspective view of SCU 110, mobile device 132, AID App 136 and aid link 130. SCU 110 is hard-wired to aid link 130, which includes a WiFi access point used to serve webpages displayed via mobile device 132 and operable to receive user instructions. The GUI of AID App 136 shows a number of user choices including:
split unit charge assist,
configuration/startup assist,
loop and accessory assist,
automated troubleshooting flowcharts,
performance diagnostics/troubleshooting,
calculators,
functional troubleshooting,
auto commissioning assist,
part search,
literature search, and
technical tip videos.

Each choice leads the user to a sub-menu presenting additional choices. For example, the user may access technical tip videos to identify a video of interest. As described below, the AID App can also direct the user to a particular video based on functional or performance testing, for example.

### Unit Charge Assist

The AID App can provide field charge assistance. A “split” air conditioning system utilizes two heat exchanging units, one located indoors (e.g., evaporator coils) and one located outdoors (e.g., a compressor and condenser). During installation of the SCU, refrigerant is charged into the coolant line. Typically, the technician charges the line and then runs the system through a variety of loads to ensure that enough coolant has been charged.

The AID App calculates the amount of refrigerant to charge into the coolant line, which can be based on the line set length and diameter, the air handler/coil, the condensing unit, and the line set diameter and length. A length estimate may be entered by the technician. The SCU includes model information for the air handler/coil, the condensing unit, and the line set diameter. Once charged, the AID App communicates with the SCU (either wirelessly or by a physical connection) to monitor various parameters (e.g., refrigerant temperature/pressure and other various calculations). The AID App then steps the unit through a variety of loads and/or modes until a steady state has been reached. If the steady state falls within correct/expected parameters, the AID App confirms that the correct amount of refrigerant has been charged. If steady state is not reached within a predetermined time, the AID App generates an alert and provides topical troubleshooting content, to be further described, herein. In this example, the topic is refrigerant charge.

The AID App will take control of the SCU and operate the SCU in both heating and cooling modes while monitoring the refrigerant pressures, temperatures, superheat and subcooling for proper operation. The AID App can the compare the results with model data and, based on the comparison, recommend refrigerant charge changes or approve current charge level. For example, a low pressure or high temperature may be indicative of insufficient refrigerant volume. The variance from the model can be used to determine how much refrigerant to add (or drain).

### Active Charge Assist

Active charge assist is provided on all splits and actively controls/monitors SCU parameters during charging, including when the AID App runs the SCU through the charging procedure. For example, the AID App will take control of the SCU and operate the SCU, similar to the split unit charge assist, when a technician is charging the unit with coolant.

### Diagnosis via Automated Troubleshooting Flow Charts

Several component diagnostic paths are included in the AID App to provide ‘flow chart’ troubleshooting (functional and performance) using a combination of user inputs (i.e. manual voltmeter readings from user) and direct unit control information (i.e. is the controller signaling the component to engage). These inputs combined allow the AID App to logically work through diagnostic flow charts to determine component failures and provide topical troubleshooting content. An example is provided with reference to flowchart 608 shown in FIG. 6.

Referring to FIG. 6, as described previously the SCU system includes user interface 132, SCU controller 120, and AID App 136. In the present example, user parameters 602 are received via user interface 132 and communicated to AID App 136. User parameters 602 can comprise, for example, a length of a conduit to be filled with refrigerant, and other data requested by AID App 136. In the present example, monitored parameters 604 are received via SCU controller 120 by AID App 136. Monitored parameters 602 can comprise, for example, values of any of the previously described sensors and any other sensors communicatively connected with the SCU controller. The values can comprise status of valves and switches in addition to values corresponding to operating ranges of sensors and components, e.g. pressure, temperature, flow, voltage, current, power, etc. In the present example, AID App 136 receives SCU identifier 126 and an instruction 606, for example to begin the installation protocol. SCU identifier 126 can be obtained with mobile device by scanning a QR or a bar code on the SCU, for example. SCU identifier 126 can also be communicated by SCU controller 120.

AID App 136 receives user parameters 602, monitored parameters 604, SCU identifier 126 and an instruction 606, and based on these received values and a model 608 proceeds to aid in the installation and troubleshooting of the SCU system, as described with reference to flowchart 600 depicting the installation and troubleshooting process. Model 608 may comprise a data-structure, e.g. tables, including acceptable operating ranges for various values. The DRs may compare actual parameter values to the model values to determine expected and unexpected results.

At 610, 620, and 630, the process performs diagnostic routines (DR) 1, 2 and N. A number of additional diagnostic routines can be performed after DR1 and DR2 and before DRN, where the letter “N” symbolizes the number of total diagnostic routines. The DR determines based on the model whether the monitored parameters present expected values (e.g. values within ranges expected by the model) or unexpected values, e.g. values outside expected ranges. A general model may comprise wide ranges or a plurality of options. The SCU identifier may be used by AID App 136 to generate or identify a SCU specific model that takes into account installation parameters, component sizing, and other specific parameters of a particular SCU system. The specific parameters may be provided upon receipt of an order for the system, which order provides the SCU system specifications. The specific parameters and other parameters may be combined in a SCU configuration file or data-structure.

If the values are unexpected, the DR may present troubleshooting content at 612, 622, and 632, where the content is directly related to the unexpected values. The unexpected values may be indicative of a fault, and the troubleshooting content may include content to troubleshoot the fault.

If the values are expected, the DR may sequence, at 614, to self-test some of the SCU components. As indicated previously, the self-test may comprise ramping the compressors through various speeds corresponding to various possible loads to determine if the amount of refrigeration fluid is sufficient. An initiate self-test user instruction may be required by SCU controller 120 to initiate the self-test. Once the instruction is received, the SCU controller 120 may control the variable speed drives to achieve various speeds, may actuate valves, may record parameter values etc. DR2 may be performed concurrently or after completion of the self-test. The instruction may be received by activating an icon on a GUI of the AID App 136. Obviously user device 132 has one screen and the code to present a request for the instruction can be provided by AID App 136. GUI 134 can present the icon the user activates to activate AID App 136.

During or as a final step in each DR, the DR records the values of the parameters for the purpose of end-to-end documenting the configuration and performance of the SCU. The AID App can also take snap shots of data at any point in the commissioning or troubleshooting processes for reporting, epicor warranty processing and replacement part ID, inventory and orders, integration with historical data, predictive maintenance and failure analysis.

### Performance Diagnostic Feature

The AID App will suggest possible causes and paths of action to improve performance of the SCU. For example, a low refrigerant volume will hinder performance and the AID App can, as described above, determine how much the refrigerant volume should change to optimize performance. At 616, for example, after performing self-test 514, the AID App can provide performance tip 1, which can be instructions to add refrigerant, adjust/tighten fittings and valves, change variable speed drive parameters such as current and torque limits, upper and lower speed limits, etc. To optimize performance, as used herein, means to bring a parameter within a predetermined range narrower than the expected range, the predetermined range being a range determined to be optimal for the SCU. Thus, if a range of 100-120 PSI is expected, a value of 104 PSI is measured, and a range of 110-112 PSI is optimal, the performance tips may be designed to move the actual pressure from 104 to 110-112. As shown, at 621 the AID App can provide performance tip 2. More performance tips can be provided based on any DR.

### Calculators

To facilitate troubleshooting, AID App provides specialized calculators, e.g. at 613, that relate a performance parameter, e.g. temperature, pressure, to a value that can be measured. A temperature thermistor calculator will determine the proper resistance of a thermistor for a given temperature. A pressure transducer calculator will determine the proper voltage on the pressure transducer for a given pressure. A capacitor calculator will determine the in-circuit capacitance of the capacitor which can then be compared to marked ratings. An antifreeze specific gravity calculator will determine the proper antifreeze mixture based upon the desired freeze protection level and the specific density reading. A geothermal loop piping volume calculator will estimate the total volume of fluid within a geothermal piping system and estimate antifreeze volume based upon desired % mixture for a given freeze protection temperature level. The freeze protection level is a temperature parameter provided by the user, although default temperature limits may be included in the SCU. In some cases, the AID application may automatically prompt the user during the troubleshooting process to access the specialized calculators.

### Functional Troubleshooting

The AID App automates troubleshooting steps by assessing the current and past operating parameters via a data lookup function. The AID App can automatically answer troubleshooting questions based on the sensor data (e.g., is the system power connected and on?) and provide the technician with targeted troubleshooting questions and related troubleshooting/repair informational videos and/or flowcharts.

Functional troubleshooting comprises flowcharts (each corresponding to a diagnosis routine as described in FIG. 6) covering circuit boards, communications, compressors, fan motors, valves etc. to determine if the particular component/subsystem is working. A user can select a troubleshooting topic from the GUI to see the flowchart. Alternatively, a start-up and/or commissioning routine links to the various troubleshooting DRs corresponding to the flowcharts, as described above with reference to FIG. 6, to partly automate, assist, and verify the installation and start-up. The flowcharts/DRs also provide configuration assistance via the GUI by providing information and requesting user parameters, as needed, for example using the calculators to obtain values measured by the installer/technician. The DRs auto diagnose performance issues of the SCU due to electrical, water, air and refrigeration conditions within the SCU.

### Auto Commissioning

Commissioning is typically performed by a technician manually placing the unit into a variety of heating and cooling conditions. The technician monitors a variety of parameters (e.g., electrical load, air temperature, refrigerant temperature and pressure, etc.) to ensure that the newly installed system is operating correctly under the variety of conditions. Once the technician performs the tests, and confirms the correct operating conditions, the unit is commissioned.

Auto commissioning is a process comprising initiating a process of operating the SCU via the AID App in heating and cooling modes while simultaneously monitoring performance and end-to-end documenting the configuration and performance of the heat SCU to satisfy design specifications. An auto-commissioning process may comprise one or more diagnosis and self-test routines, as described with reference to FIG. 6. Auto commissioning thus provides a level of verification not possible in the typical commissioning process, at least due to the assurance that the process was performed in the prescribed manner and the parameter values were obtained at precisely designated times.

The AID App can perform commissioning steps automatically by communicating with the HVAC unit, running the equipment through various heating and cooling modes, and recording performance parameters and configuration data corresponding to the modes. The AID App documents the setup and performance of the HVAC unit after installation for the contractor to verify correct installation and commissioning. The values of the parameters obtained by the AID App during commissioning may be referred to as “control-verified” parameter values, to recognize that these values are not subject to user input or modification, and are therefore very reliable.

The AID App may instruct the user to perform an action to correct a fault, e.g. switch manual to auto, increase airflow, etc.

The AID App may receive a configuration file from the SCU controller and use the GUI to customize the configuration with user inputs. The customized configuration file can then be downloaded to the SCU controller. The customized configuration file can also be downloaded to other SCUs sharing the same configuration, thus facilitating customization of multiple systems.

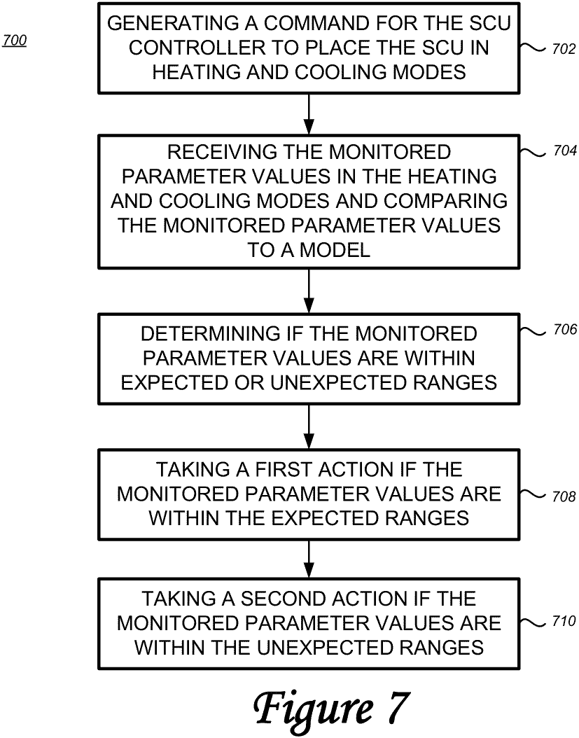

FIG. 7 is a flowchart of an embodiment of an auto-commissioning process. The process is executed in a space conditioning system comprising an AID application comprising processing instructions operable by a processor to perform the process. The process includes presenting a GUI on a display screen, the GUI operable to receive user parameter values from a user; receiving monitored parameter values from a SCU controller; and perform an auto-commissioning routine using the user parameter value and the monitored parameter values, the auto-commissioning routine including: at 702, generating a command for the SCU controller to place the SCU in heating and cooling modes; at 704, receiving the monitored parameter values in the heating and cooling modes and comparing the monitored parameter values to a model; at 706, based on the comparison, determining if the monitored parameter values are within expected or unexpected ranges; at 708, taking a first action if the monitored parameter values are within the expected ranges; and at 710, taking a second action if the monitored parameter values are within the unexpected ranges.

As used herein, a processing or computing system or device may be a specifically constructed apparatus or may comprise general purpose computers selectively activated or reconfigured by software programs stored therein. The computing device, whether specifically constructed or general purpose, has at least one processing device, or processor, for executing processing instructions and computer readable storage media, or memory, for storing instructions and other information. Many combinations of processing circuitry and information storing equipment are known by those of ordinary skill in these arts. A processor may be a microprocessor, a digital signal processor (DSP), a central processing unit (CPU), or other circuit or equivalent capable of interpreting instructions or performing logical actions on information. A processor encompasses multiple processors integrated in a motherboard and may also include one or more graphics processors and embedded memory. Exemplary processing systems include workstations, personal computers, portable computers, portable wireless devices, mobile devices, and any device including a processor, memory and software. Processing systems also encompass one or more computing devices and include computer networks and distributed computing devices.

As used herein, a communications network is a system of computing systems or computing devices interconnected in such a manner that messages may be transmitted between them. Typically one or more computers operate as a “server”, a computer with access to large storage devices such as hard disk drives and communication hardware to operate peripheral devices such as printers, routers, or modems. Other computers, termed “clients”, provide a user interface so that users of computer networks can access the network resources, such as shared data files, common peripheral devices, and inter workstation communication. User interfaces may comprise software working together with user input devices to communicate user commands to the processing system. Exemplary user input devices include touch-screens, keypads, mice, voice-recognition logic, imaging systems configured to recognize gestures, and any known or future developed hardware suitable to receive user commands.

As used herein, a non-transitory computer readable storage medium comprises any medium configured to store data, such as volatile and non-volatile memory, temporary and cache memory and optical or magnetic disk storage. Exemplary storage media include electronic, magnetic, optical, printed, or media, in any format, used to store information. Computer readable storage medium also comprises a plurality thereof.

The features and embodiments of the AID App described above, in conjunction with the SCU controller and an SCU comprising a data acquisition suite enable reductions in installation and service complexity and time for dealers and installers. In turn, the improvements can reduce warranty costs by identifying suboptimal performance and component failures. A more credible verification of the installation and start-up process can also support warranty claims.

Furthermore, the provision of targeted troubleshooting content can be optimized by maintaining the troubleshooting content up-to-date in a server, thus the AID App can access the most current content instead of providing content as it was when the SCU was acquired, e.g. manuals and CDs.

The above detailed description of the invention and the examples described therein have been presented only for the purposes of illustration and description. It is therefore contemplated that the present invention cover any and all modifications, variations or equivalents that fall within the spirit and scope of the basic underlying principles disclosed above and claimed herein.

What is claimed is:

1. A space conditioning system comprising:
an AID application comprising processing instructions operable by a processor to:
present a graphical user interface (GUI) on a display screen, the GUI operable to receive user parameter values from a user;
receive monitored parameter values from a space conditioning unit (SCU) controller, and
perform an auto-commissioning routine using the user parameter value and the monitored parameter values, the auto-commissioning routine including:
generating a command for the SCU controller to place the SCU in heating and cooling modes;
receiving the monitored parameter values in the heating and cooling modes and comparing the monitored parameter values to a model;
based on the comparison, determining if the monitored parameter values are within expected or unexpected ranges;
taking a first action if the monitored parameter values are within the expected ranges; and
taking a second action if the monitored parameter values are within the unexpected ranges.

2. The space conditioning system of claim 1, further comprising a SCU including the SCU controller.

3. The space conditioning system of claim 2, further comprising an AID link wired to the SCU and providing an access point to transmit the monitored parameter values to the AID application and to receive from the AID application the user parameter values from the user.

4. The space conditioning system of claim 1, wherein the SCU includes an SCU identifier and wherein the processing instructions of the AID application are configured to receive the SCU identifier and to select a model based on the SCU identifier.

5. The space conditioning system of claim 1, wherein the SCU includes an SCU identifier and wherein the processing instructions of the AID application are configured to receive the SCU identifier and to reconfigure a general model into the model based on the SCU identifier.

6. The space conditioning system of claim 1, wherein the first action comprises storing the monitored parameter values to verify installation based on the auto-commissioning routine.

7. The space conditioning system of claim 1, wherein the second action comprises presenting topical troubleshooting content.

8. The space conditioning system of claim 1, wherein the auto-commissioning routine comprises processing instructions configured to store control-verified parameter values.

9. The space conditioning system of claim 1, wherein the processing instructions of the AID application are configured to present a calculator operable to convert an SCU parameter value into a measurable parameter value and to receive a user input comprising the measurable parameter value.

10. The space conditioning system of claim 1, wherein auto-commissioning routine comprises processing instructions configured to calculate an estimated refrigerant charge based upon an air handler/coil, a condensing unit and a line set diameter and length.

11. The space conditioning system of claim 1, wherein auto-commissioning routine comprises processing instructions configured to compare refrigerant pressures, temperatures, superheat and subcooling to determine if an amount of the refrigerant charge in the space conditioning system is sufficient.

12. The space conditioning system of claim 11, wherein auto-commissioning routine comprises processing instructions configured to present an amount of increase or decrease of the refrigerant charge if the amount of the refrigerant charge in the space conditioning system is not sufficient.

13. A space conditioning system comprising an AID application including processing instructions operable by a processor to:
present a graphical user interface (GUI) on a display screen, the GUI operable to receive user parameter values from a user;
communicate with an SCU controller of a space conditioning unit;
receive monitored parameter values from the SCU controller; and
perform a charge assist routine based upon the user parameter values and the monitored parameter values.

14. The space conditioning system of claim 13, wherein the user parameter comprises a coolant line length, the monitored parameter values comprise a refrigerant temperature and/or a refrigerant pressure, and the charge assist routine comprises:
calculating an amount of refrigerant to charge into a coolant line based upon the coolant line length, and
determining if a correct amount of refrigerant has been supplied to the space conditioning system based upon a determined steady state operation of the space conditioning system.

15. The space conditioning system of claim 14, wherein the determination of the steady state operation comprises:
generating a command for the SCU controller to place the space conditioning unit in a heating mode or a cooling mode;
receiving the monitored parameter values during the heating mode or the cooling mode;
comparing the monitored parameter values to a model; and
determining if the monitored parameter values are within an expected range or an unexpected range for a predetermined timeframe.

16. The space conditioning system of claim 15, wherein:
when the monitored parameter values are determined to be within the expected range for the predetermined timeframe, automatically generate an indication displayed on the GUI confirming that a correct amount of refrigerant has been supplied, or
when the monitored parameter values are within the unexpected range, automatically generate an indication displayed on the GUI alerting that an incorrect amount of refrigerant has been supplied.

17. A space conditioning system comprising an AID application including processing instructions operable by a processor to:
present a graphical user interface (GUI) on a display screen, the GUI operable to receive user parameter values from a user;
communicate with an SCU controller of a space conditioning unit;
receive monitored parameter values from the SCU controller; and
perform one or more routines based upon the user parameter values and the monitored parameter values.

18. The space conditioning system of claim 17, wherein the one or more routines comprises a troubleshooting routine, the troubleshooting routine comprising:
performing a diagnostic routine including determining if the monitored parameter values are within an expected range or an unexpected range, and
based upon the determination of the unexpected range, displaying troubleshooting content on the GUI indicating a flowchart for troubleshooting a parameter associated with the space conditioning system.

19. The space conditioning system of claim 17, wherein the one or more routines comprises a performance diagnostic routine, the performance diagnostic routine comprising:
performing a diagnostic routine comprising determining if the monitored parameter values are within an expected range or an unexpected range, and
based upon the determination, optimizing the operation of the space conditioning system based upon adjusting a parameter associated with the space conditioning unit by communicating with the SCU controller, the optimizing automatically enhancing the performance of the space conditioning system.

20. The space conditioning system of claim 17, wherein the one or more routines comprises a functional troubleshooting routine, the functional troubleshooting routine comprising:
automatically generating responses to one or more user questions relating to the space conditioning unit and displaying the responses on the GUI;
displaying one or more flowcharts on the graphical user interface relating to the space conditioning unit in response to the user parameter values and the monitored parameter values; and/or
displaying one or more videos on the GUI relating to the space conditioning unit in response to the user parameter values and the monitored parametervalues.
